(19) United States
(12) Patent Application Publication
(10) Pub. No.: US 2006/0112608 A1
(43) Pub. Date: Jun. 1, 2006

(54) Fishing lure

(75) Inventor: Thomas Ray Snyder, Flagstaff, AZ (US)

Correspondence Address: LAW OFFICE OF MICHELE HOLDEN, SUITE 7, 212 N. 4TH STREET, KINGMAN, AZ, 86401, US

(73) Assignee: TOMMY'S TANDEM & ASSOCIATES

(21) Appl. No.: 11/222,925

(22) Filed: Sep. 8, 2005

Related U.S. Application Data
(63) Continuation-in-part of application No. 10/998,865, filed on Nov. 29, 2004.

(51) Int. Cl. A01K 85/18; A01K 85/00

(52) U.S. Cl. 43/42.15; 43/42.05; 43/42.47; 43/42.36

(57) ABSTRACT

An improved fishing lure is disclosed. The improved fishing lure of the present invention emulates a prey fish being hunted by a predator fish and comprises a prey fish lure having a connector line for attaching a predator lure to the improved fishing lure. In one embodiment, the connector line is attached through a hole in the prey fish lure and includes a loop on one end to attach a predator lure of the fishermen's choice to the prey fish. The connector line further includes a loop at the other end for connecting a leader line. The prey fish lure is allowed to slide up and down a portion of the connector line to further simulate the movement of a prey fish in the water.

This application is a continuation-in-part of U.S. patent application Ser. No. 10/998,865, filed Nov. 29, 2004, which is herein incorporated by reference in its entirety.

### BACKGROUND

1. Field of the Invention

The present invention relates generally to fishing lures. More particularly, the present invention relates to improved fishing lures for use by game fishermen.

2. Background of the Invention

Fishing lures are well known in the art. A typical conventional fishing lure is shown in FIG. 1. Fishing lure 10 comprises body 12 designed to appear like a particular species of fish having one or more hooks 14 to snare the game fish and leader coupler 16 or similar means to attach the body to a fishing line (not shown in FIG. 1). Lures are typically dragged through the water to mimic the movement of the particular fish being imitated by the lure. Lures may be cast into a body of water and drawn in using a fishing reel to move the lure thereby simulating action of a live bait fish. Alternatively, lures may be dragged behind a boat in a method know as trolling.

Many in the art have sought to design lures having particular characteristics to provide the best illusion that the lure is a real fish. For example, some lures are painted with precise patterns to match the patterns of a particular species of fish. Other lures have moving parts that create disturbance in the water to gain the attention of the game fish. Other lures have fins to better emulate the movement of the fish through the water.

Known lures typically emulate a single fish. The concept behind such lures appears to be that a single fish swimming in the water will appear to the game fish as an attractive prey. Game fish are predatory in nature. Accordingly lures are designed to appear like the natural prey of the fish being sought. In essence known lures and baiting techniques attempt to trick the game fish with the notion of available food as a single prey item.

Some known lures have attempted to emulate schools of fish wherein all of the fish in the school are essentially of the same size and type. U.S. Pat. No. 4,794,721 to Rowe et al., and U.S. Pat. No. 6,185,857 to Hnizdor, disclose such lures. In both cases, the lures disclosed therein emulate a school of smaller fish, such as minnows, swimming through the water. By mimicking the known behaviors of such smaller fish, i.e., swimming in groups, such lures present a plausible bait for the game fish. Further, the game fish may be attracted by the number of fish in the vicinity of the lure and may attempt to catch one of the school.

Known lures and baits, including single lure and school lures have been successful to varying degrees. However, there is a need for an improved fishing lure that has a much greater probability of success in catching larger fish with greater frequency.

### SUMMARY OF THE INVENTION

The present invention discloses an improved fishing lure. The improved fishing lure of the present invention emulates a prey fish being hunted by a predator fish. An improved fishing lure according to the present invention comprises a prey fish having a leader coupler and a predator connector coupler; and a connector line attached to the predator connector coupler thereby providing a means for connecting a predator lure to the prey fish. The connector line may be made of any suitable material and the prey fish may be designed to emulate a specific species of fish. A predator fish lure may be attached to the improved fishing lure of the present invention to complete to illusion of a fish being hunted. An embodiment of the present invention also includes a prey lure having one or more joints to allow increased movement by the prey lure to further enhance the illusion of a predator-prey environment.

The size of the prey fish lure and the length of the connector line are selected according to the fishing environment in which the improved fishing lure are to be used. The predator lure selected for use with an improved fishing lure of the present invention should be at least as large as the prey lure.

### BRIEF DESCRIPTION OF THE DRAWINGS

FIG. 1 shows a conventional fishing lure.

FIG. 2 shows a first embodiment of the present invention, wherein a conventional fishing lure has been adapted to create a prey lure according to the present invention.

FIG. 3 shows the first embodiment of the present invention used in conjunction with a conventional fishing lure.

FIG. 4 shows the first embodiment of the present invention including a tubing to provide rigidity for casting when using monofilament nylon fishing line for the connector line.

FIG. 5 shows a second embodiment of the present invention, wherein a prey lure has been specifically designed according to the present invention.

FIG. 6 shows a first variation of the second embodiment of the present invention, wherein a prey lure has been specifically designed according to the present invention.

FIG. 7 shows a second variation of the second embodiment of the present invention, wherein a prey lure has been specifically designed according to the present invention.

FIG. 8 shows crimping configuration suitable for use with a titanium leader in an embodiment of the present invention.

FIG. 8A shows a cross-sectional view of the crimping configuration shown in FIG. 8.

FIG. 8B shows another cross-sectional view of the crimping configuration shown in FIG. 8.

FIG. 9 shows an embodiment of the present invention, wherein the prey lure is connected directly to the connector line without the need for a connector coupler.

FIG. 10 shows a variation of the embodiment of the present invention shown in FIG. 9, wherein the connector line passes through a fin on the prey fish lure.

FIG. 11 shows another variation of the embodiment of the present invention shown in FIG. 9, wherein the connector line includes a bead to further gain the attention of a game fish.

FIG. 12 shows another variation of the embodiment of the present invention shown in FIG. 9, wherein the connector line includes a plurality of beads to further gain the attention of a game fish.

### DETAILED DESCRIPTION OF THE INVENTION

The present invention comprises a system and method for catching larger predatory fish with greatly improved results over known fishing lures and methods. It is believed that the greatly improved fishing results of the present invention can be attributed to the predator/prey instincts of game fish. The present invention provides the illusion to the target game fish that a predator fish is engaged in the hunt for a smaller prey fish. It is believed that the present invention is successful, at least in part, because it provides a vulnerable prey to the game fish being sought.

It is a well-known observation in any predator/prey environment that the prey is most vulnerable when it is engaged in certain life cycle events: courtship, mating, protecting and caring for offspring, and feeding. For example if the prey is engaged in mating it may not be as aware of a predator closing in for the kill. Similarly, when an animal or fish is feeding it may not be focused on any lurking danger from its natural enemies. When a predator is, itself, engaged in seeking its prey, it too becomes more vulnerable to its own natural enemies. That is, while a predatory animal or fish is focused on the hunt, it in turn becomes an easier target for another larger predatory animal or fish. The present invention provides a system and method for emulating a predator fish in close pursuit of its prey. In turn, the predator fish becomes the prey for the game fish.

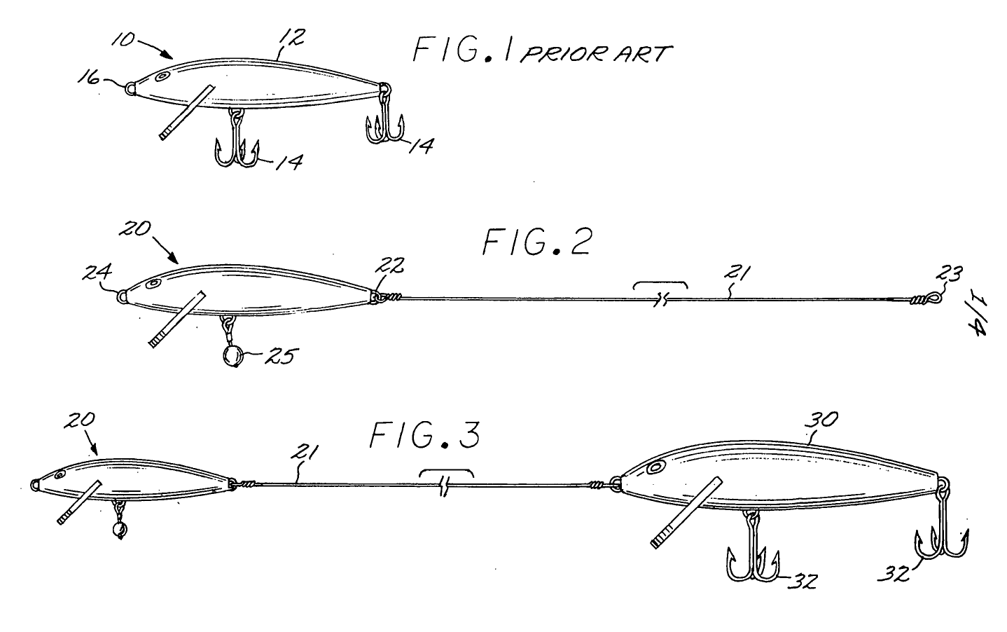

FIG. 2 shows an embodiment of the present invention. The present invention comprises prey fish 20 (also referred to herein as “prey lure”) attached to connector line 21 by predator connector coupler 22. Coupling devices for fishing apparatus are well known in the art. Accordingly, predator connector coupler 22 may comprise a split ring as shown in FIG. 2, a snap, a speed clip, or any other suitable coupling device. Connector line 21 may be any suitable cord or wire and is used to connect the prey fish to a predator fish lure. The choice of material for connector line 21 depends on the intended application and the desire to limit costs. For example, it has been found that titanium wire is optimal for casting applications wherein the game fish to be caught are very large. However, titanium is also more costly than other acceptable materials. Stainless steel, which is less costly than titanium, is also suitable. However, it has been found that very large fish may cause kinks in the wire, resulting in frequent breakage. Monofilament nylon, e.g., standard fishing line, may be used and has been found particularly useful for trolling applications wherein the water is clear. Stainless steel and titanium is also suitable for trolling operations wherein the water is either clear or murky.

Connector line 21 includes loop 23 used to attach connector line 21 to the predator lure as shown in FIG. 3. As would be apparent to one of skill in the art, loop 23 may be any connector to facilitate the attachment of a predator lure to a fishing lure apparatus according to the present invention. When the connector line is made using titanium, a crimped connection such as shown in FIG. 8 is preferable. In this configuration, loop 79 is formed by crimping stainless steel cable 75 to titanium line 76 using crimp 77. To achieve a good grip within crimp 77, titanium line 76 forms a smaller loop 78 inside larger 79. Loop 78 may be partially or wholly inside crimp 77 and is essentially in a plane perpendicular to loop 79, formed by stainless steel cable 75. This can be better seen in FIG. 8A, where the two distal ends of stainless steel cable 75 are perpendicular to the portions of titanium wire 76 forming loop 78. FIG. 8B shows the inner details of a rigging for use with a titanium connector according to the present invention. This configuration works better than the standard twisted loop such as shown in FIG. 2, because the flexibility of titanium wiring does not form a tight twist necessary to support the added weight of lures made according to the present invention and the larger fish caught with such lures. By using a hybrid loop such as described herein, an improved fishing lure of the present invention has the strength necessary to support the lure and the large game fish which may be caught. The stainless steel cable may have a coating or other sleeve around the cable to provide additional gripping within the crimp or to provide additional coloring to attract the game fish. For example, in one embodiment, stainless steel cable 75 may include a red nylon coating which further simulates blood thereby attracting game fish.

Prey fish 20 further includes leader coupler 24 which is used to attach a fishing line or leader (not shown in FIG. 2) to the prey fish. As known in the art, loop 23 and leader coupler 24 may be any suitable device for attaching one fishing tackle component to another. Further as would be apparent to one skilled in the art, the positioning leader coupler 24 and predator connector coupler 22 on the body of prey fish 20 is a design choice not limited to the positioning shown in the Figures herein.

Prey fish 20 may be any suitable lure adapted as described herein and should be sufficiently smaller in size in comparison to the predator lure (not shown in FIG. 2) to foster the illusion that the prey fish 20 is being hunted by the predator. Notably, prey fish 20 need not have any hooks to catch the game fish. This is so because, as shown in FIG. 3, prey fish 20 is not the prey of the game fish. That is, prey fish 20 is not the object to be caught by the game fish. Prey fish 20 may even be a conventional fishing lure adapted according to the present invention. Instead of having one or more fishing hooks, prey fish 20 is attached to connector line 21, which in turn may be attached to a predator lure of the fisherman's choice. Further, prey fish 20 may optionally include auxiliary attachments such as facetted bead 25 to further attract attention of the game fish. Using a red-colored bead or other attachment (simulating bleeding) further enhances the illusion that prey fish 20 may be wounded as it is being chased by the predator lure. As known in the art, the auxiliary attachment may be any attachment to increase to visibility of the lure thereby attracting the game fish's attention.

FIG. 3 shows an embodiment of the present invention wherein prey fish 20 is attached to predator lure 30 via connector line 21. As shown in FIG. 3, prey fish 20 is sufficiently smaller than predator lure 30. Predator lure 30 includes one or more hooks 32 used to catch the game fish. Predator lure 30 may be any conventional fishing lure so long as it is at least a large as the prey fish. Preferably, the predator lure is at least 20% larger than the prey fish to emphasize the illusion that the predator lure is hunting the prey fish.

As described above, connector line 21 may be made of any suitable material. The increased weight of a fishing lure according to the present invention (due to having dual lures) makes casting somewhat more difficult to manage when using a monofilament connector line. In one variation of the present invention, semi-rigid tubing 40 may be included around connector line 21 as shown in FIG. 4. Such tubing is particularly useful to provide rigidity for casting when using a connector line made of monofilament nylon.

FIG. 5 shows a second embodiment of the present invention, wherein a prey lure has been specifically designed according to the present invention. In this embodiment, prey fish 50 comprises two separate parts, head 51 and tail 52, connected to one another by joint 53. Prey fish 50 is attached to connector line 54 via predator connector coupler 55 which is attached to head 51. Finally, prey fish 50 includes leader coupler 56 on head 51 which is used to attach fishing line 57 to prey fish 50. Joint 53 may be a pair of rings as shown in FIG. 5. Alternatively, joint 53 may be any suitable means for connecting the head to the tail, such that the two components some range of movement with respect to each other.

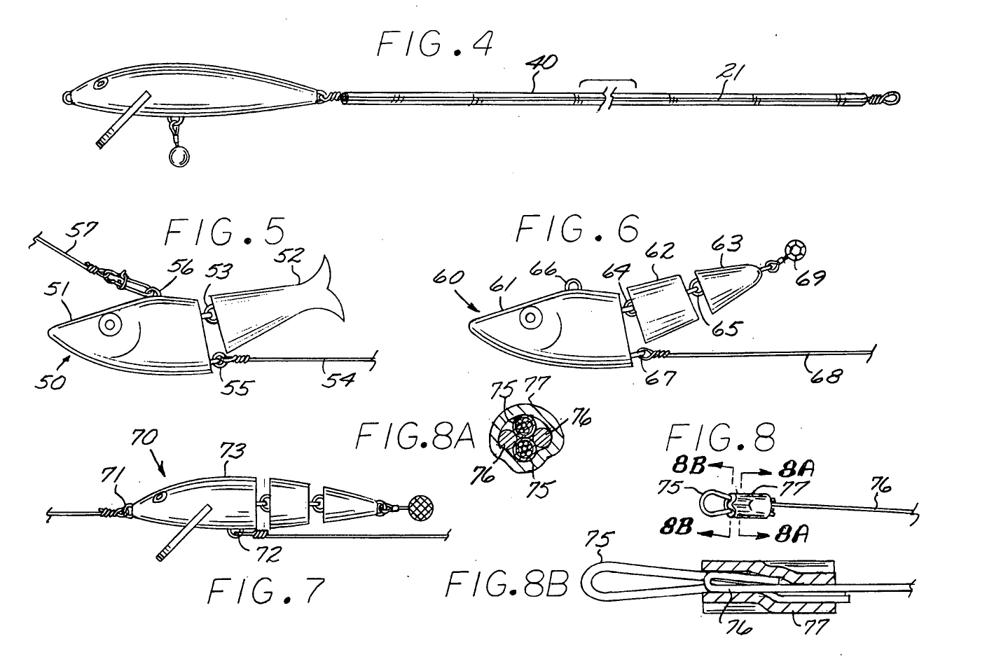

FIG. 6 shows a first variation of the second embodiment of the present invention, wherein a prey lure has been specifically designed according to the present invention. In this variation, prey fish 60 comprises head 61, body 62 and tail 63 connected by joints 64 and 65 as shown in FIG. 6. Head 61 of prey fish 60 includes coupler 66 used to attach a fishing line (not shown in FIG. 6) and coupler 67 used to attach connector line 68, as shown in FIG. 6. Faceted bead 69 or other attachments may optionally be added to tail 63 or to other points on prey fish 60. As described herein, such attachments may serve to enhance the illusion that the prey fish is wounded and is vulnerable to the predator lure in close pursuit.

FIG. 7 shows a second variation of the second embodiment of the present invention, wherein a prey lure has been specifically designed according to the present invention. Prey fish 70, shown in FIG. 7, is essentially the same as prey fish 60 shown in FIG. 6, but illustrates that the couplers 71 and 72 may be placed at different points on head 73 of prey fish 70. As would be apparent to one of ordinary skill in the art, variations in positioning of the couplers will cause variations in the manner of the movement of the prey fish through the water in relation to the tension on the fishing line and the predator lure being dragged behind the prey fish.

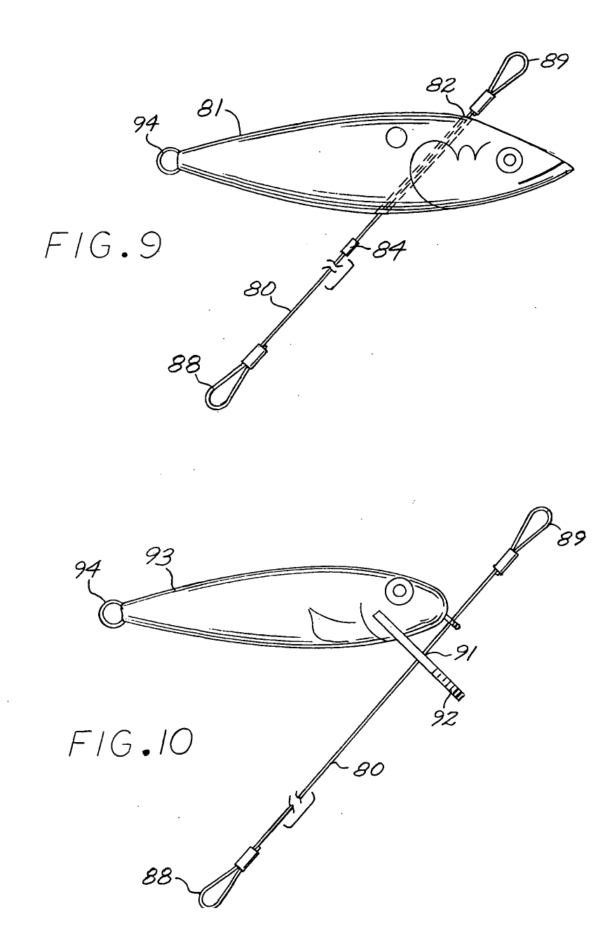

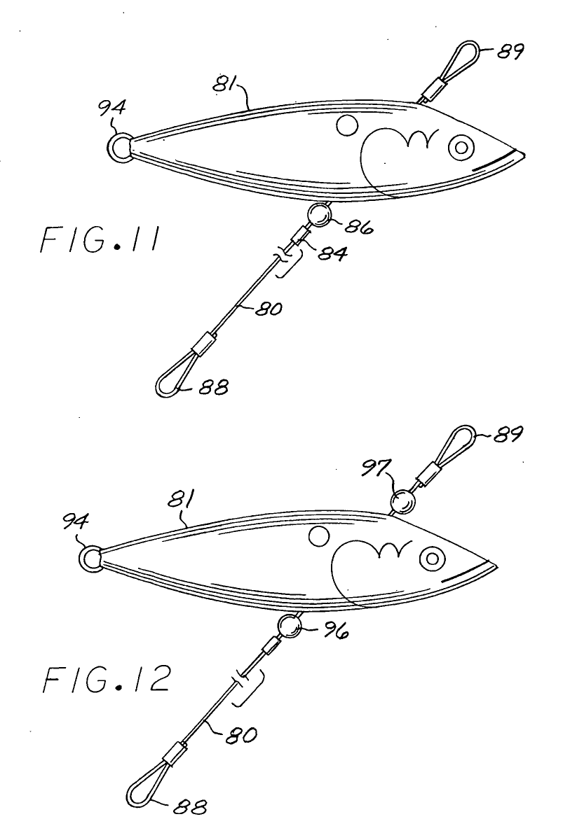

FIG. 9 shows an embodiment of the present invention, wherein the prey lure is connected directly to the connector line without the need for a connector coupler or a prey coupler on the body of the prey lure. As shown in FIG. 9, connector line 80 passes through a portion of prey lure 81. In this embodiment, hole 82 is made in the body of the prey lure using any suitable technique, including but not limited to drilling, melting or puncturing the body. Hole 82 through prey lure 81 may be through the body of prey lure 81 as shown in FIG. 9. Alternatively, connector wire 80 may pass through hole 91 on fin 92 of prey lure 93 as shown in FIG. 10.

Connector line 80 includes first loop 88 and second loop 89 as shown in FIGS. 9 through 12. First loop 88 is the same as loop 23 described herein for attaching a predator lure to the improved fishing lure apparatus of the present invention. Second loop 89 has similar function, but is used to attach the improved fishing lure apparatus of the present invention to a fishing line or leader. As described herein, loops 88 and 89 may be any connector to facilitate the attachment of two fishing apparatus. For example each end of connector line 80 may crimped to form a loop on each end as shown in the Figures. In this embodiment, connector line 80 is preferably made of titanium wire.

Connector line 80 preferably passes through the prey lure in manner such that the lure is capable of limited movement up and down the line. As shown in FIG. 9, bottom block 84 may be used to fix the downward movement of prey lure 81 to that linear space between bottom block 84 and connector loop 89. Bottom block 84 may be made using any suitable means. In one embodiment, bottom block 84 is made by crimping a sleeve around connector line 80 at a point below the prey lure as shown in FIG. 9. As would be apparent to one of ordinary skill in the art, a second block (not shown in the Figures) may be used at a point above prey lure 81 to further restrict upward movement of prey lure 81.

In one embodiment, one or more beads may be attached to connector line 80 to further simulate the illusion of a live prey fish. Beads, if used may be included above and/or below prey fish 81 as shown in FIGS. 11 and 12. In FIG. 11, only one bead, bead 86, is used and is placed below prey lure 81. In FIG. 12, two beads, bead 96, positioned below prey lure 81, and bead 97, positioned above prey lure 81, are used. As shown in FIGS. 11 and 12, the beads are preferably secured by the blocks such that the beads are allowed to move along connector line 80 with prey lure 81. As would be apparent to those skilled in the art more than one bead may be placed at each position on connector line 80. Further, the beads, if used, could be securely attached to connector line 80 so as to serve at the blocks limiting prey lure 81's linear movement along connector line 80.

As would be apparent to those skilled in the art, other design considerations may be important depending on the application. For example, the specific designs or patterns on the prey fish and predator lure may be selected to emulate the same species of fish (one hunting the other). Alternatively, the prey fish may be selected to emulate one species while the predator lure may be selected to emulate a natural enemy of the prey fish. Other design considerations include the specific ratio of the length of the predator lure to the length of the prey lure. The ratio of the length of predator lure 30 to the length of prey fish 20 is optimally 1.2 or greater. However, it has been found that any ratio 1.0 or greater works better for catching more and larger game fish than conventional single lures or school lures.

Another design consideration is the length of the connector line which establishes the distance between the predator lure and the prey fish. The optimal distance between the hunter (predator lure) and the hunted (prey fish) depends on the size of the lure and prey fish as shown in Table 1. Varying lengths of predator lures are identified across the top of Table 1, while varying lengths of prey fish are identified down the first column of Table 1. The body of the table identifies a length of the connector between the two which has been tested for fishing results. While other lengths of connector are workable according to the present invention, the lengths shown in Table 1 have been highly successful for catching game fish.

TABLE 1
Connector length as function of prey fish and
predator lure lengths (all data in inches)

| | | Predator Lure (length in inches) | | | | | | | | | | | | | | |
|---|---|---|---|---|---|---|---|---|---|---|---|---|---|---|---|---|
| | | 0.5 | 1 | 1.5 | 2 | 2.5 | 3 | 3.5 | 4.0 | 5.0 | 6.0 | 7.0 | 8.0 | 9.0 | 10 | 12 |
| Prey Lure | 0.5 | 8 | 8 | 8 | 8 | 9 | 9 | 10 | 10 | 11 | 11 | 12 | 12 | 13 | 13 | 14 |
| (length in | 1.0 | — | 8 | 8 | 8 | 8 | 9 | 9 | 10 | 10 | 11 | 11 | 12 | 12 | 13 | 13 |
| inches) | 1.5 | — | — | — | — | 9 | 9 | 10 | 10 | 11 | 11 | 12 | 12 | 13 | 13 | 14 |
| | 2.0 | — | — | — | — | — | 9 | 10 | 10 | 11 | 11 | 12 | 12 | 13 | 13 | 14 |
| | 2.5 | — | — | — | — | — | — | 10 | 11 | 11 | 12 | 12 | 13 | 13 | 14 | 14 |
| | 3.0 | — | — | — | — | — | — | — | 11 | 12 | 12 | 13 | 13 | 14 | 14 | 14 |
| | 3.5 | — | — | — | — | — | — | — | 12 | 12 | 13 | 13 | 14 | 14 | 14 | 14 |
| | 4.0 | — | — | — | — | — | — | — | — | 12 | 12 | 13 | 13 | 14 | 14 | 14 |
| | 4.5 | — | — | — | — | — | — | — | — | — | 12 | 12 | 13 | 13 | 14 | 14 |
| | 5.0 | — | — | — | — | — | — | — | — | — | 12 | 12 | 13 | 13 | 14 | 14 |
| | 5.5 | — | — | — | — | — | — | — | — | — | — | 12 | 13 | 14 | 14 | 14 |
| | 6.0 | — | — | — | — | — | — | — | — | — | — | 13 | 14 | 14 | 14 | 14 |
| | 6.5 | — | — | — | — | — | — | — | — | — | — | — | 13 | 14 | 14 | 14 |
| | 7.0 | — | — | — | — | — | — | — | — | — | — | — | 13 | 14 | 14 | 14 |
| | 7.5 | — | — | — | — | — | — | — | — | — | — | — | — | 14 | 14 | 14 |
| | 8.0 | — | — | — | — | — | — | — | — | — | — | — | — | 14 | 14 | 14 |

The present invention attempts to more closely emulates the optimal environment for catching predatory fish. Predatory fish, like most other preying species, have been observed to be most vulnerable when they are engaged in certain life-cycle events such as courtship, mating, caring for young, defending territories and feeding. It has been noted that many species can be approached and even captured while they are in engaged in such activities. The present invention appears to work well because, a predator fish engaged in the process of preying on a smaller fish is more easily captured by an even larger predator fish. The present invention emulates this optimal scenario by creating the illusion that a small fish is in the process of being preyed upon by a larger predatory fish. This larger predatory fish in thus more vulnerable to attack by an even larger predatory fish. It is the larger predatory fish that is snared by method and system of the present invention.

While the theory as to why the present invention works to increase the size of the fish caught and the frequency of bites when compared to conventional fishing lures appears sound, it is possible that the present invention works due to some other biological or environmental factors not considered herein. The theory of why it works is not an important aspect of the present invention. What is important is that one fishing for game fish using a fishing lure according to present invention will one average catch more fish and will catch larger fish than was likely with a conventional fishing lure.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An improved fishing apparatus comprising a prey fish lure and a connector line, wherein the connector line passes through a hole in the prey fish lure and wherein the connector line comprises a first loop on a first end and a second loop on a second end.

2. The improved fishing lure apparatus of claim 1, wherein the connector line is made from titanium metal.

3. The improved fishing lure apparatus of claim 2, wherein the first loop comprises a stainless steel cable having two ends wherein the two ends of the stainless steel cable are connected to the first end of the connecter line thereby forming the first loop.

4. The improved fishing lure apparatus of claim 3, wherein a crimping sleeve is used to connect the two ends of the stainless steel cable to the first end of the connector line.

5. The improved fishing lure apparatus of claim 4, wherein the first end of the connector line forms an inner loop within the crimping sleeve and the first loop lays in a plane essentially perpendicular to the inner loop.

6. The improved fishing lure apparatus of claim 3, wherein the stainless steel cable comprises a nylon coating.

7. The improved fishing lure apparatus of claim 1, wherein the connector line is made from stainless steel metal.

8. The improved fishing lure apparatus of claim 1, further comprising a first block attached to the connector line such that the prey fish lure is between the first block and the second loop.

9. The improved fishing lure apparatus of claim 8, further comprising a second block attached to the connector line such that the prey fish lure is between the first block and the second block.

10. The improved fishing lure apparatus of claim 1, wherein the prey fish lure is at least 0.5 inches in length and the connector line is at least 8.0 inches in length.

11. The improved fishing lure apparatus of claim 1, wherein the prey fish lure is between 0.5 inches and 8.0 inches in length and the connector line is between 8.0 inches and 14.0 inches in length.

12. The improved fishing lure apparatus of claim 1, further comprising a predator lure attached to the first loop, wherein the predator lure includes hooks for catching a game fish and wherein a ratio of a length of the predator lure to a length of the prey fish lure is at least 1.0.

13. The improved fishing lure apparatus of claim 12, wherein the ratio of the length of the predator lure to the length of the prey fish lure is at least 1.20.

14. The improved fishing lure apparatus of claim 12, wherein the ratio of the length of the predator lure to the length of the prey fish lure is at least 1.50.

15. The improved fishing lure apparatus of claim 12, wherein the ratio of the length of the predator lure to the length of the prey fish lure is between 1.2 and 12.0.

16. The improved fishing lure apparatus of claim 12, wherein the prey fish lure and the predator lure have the same species markings thereon.

17. The improved fishing lure apparatus of claim 12, wherein the prey fish lure and the predator lure have different species markings thereon.

18. The improved fishing lure apparatus of claim 1, wherein the connector line passes through a first hole in a first bead.

19. The improved fishing lure apparatus of claim 18, further comprising a first block attached to the connector line wherein the prey fish lure is positioned between the first block and the second loop and the first bead is positioned between the first block and the prey fish lure.

20. The improved fishing lure apparatus of claim 19, wherein the connector line passes through a second hole in a second bead.

21. The improved fishing lure apparatus of claim 20, further comprising a second block attached to the connector line such that the second bead is positioned between the prey fish and the second block.

22. The improved fishing lure apparatus of claim 1, wherein the hole in the prey fish lure passes through a body of the prey fish lure.

23. The improved fishing lure apparatus of claim 1, wherein the prey fish lure includes a fin attached to the prey fish lure and wherein the hole in the prey fish lure passes through the fin.

24. An improved fishing lure comprising:
(a) a prey fish;
(b) a connector line having a first loop on a first end and second loop on a second end; and
(c) a predator lure having at least one hook mechanism and a prey connector coupler; wherein the connector line passes through a hole in the prey fish, wherein the prey fish is positioned between the first loop and the second loop on the connector line, and the prey connector coupler is attached to the first loop of the connector line.

25. The improved fishing lure of claim 24, wherein the prey fish is sufficiently smaller in size than the predator lure to create an illusion that the prey fish is being hunted by the predator lure.

26. The improved fishing lure of claim 24, wherein the predator lure is at least 20% greater in size than the prey fish.

27. The improved fishing lure of claim 24, wherein the prey fish further includes a first set of species markings and the predator lure includes a second set of species markings.

28. The improved fishing lure of claim 24, wherein the first and second sets of species markings are related to the same species.

29. The improved fishing lure of claim 24, wherein the first and second sets of species markings are related to different species.

30. An improved fishing lure apparatus comprising a prey fish lure means for emulating a fish being hunted by a predator fish; a predator lure means for emulating a predator fish in the process of hunting a prey fish; and a means for connecting the predator lure means to the prey fish lure means.

31. The improved fishing lure apparatus of claim 30, wherein the means for connecting the predator lure comprises a connector line passing through the prey fish lure means, wherein the predator lure means is connected to a first loop on a first end of the connector line and a second end of the connector line includes means for attaching the connector line to a fishing line.

32. The improved fishing lure apparatus of claim 31, wherein the connector line further comprises a first blocking means to limit the linear movement of the prey fish lure means along a length of the connector line.

33. The improved fishing lure apparatus of claim 32, wherein the connector line further comprises a second blocking means to limit the linear movement of the prey fish lure means along a length of the connector line between the first blocking means and the second blocking means.

34. The improved fishing lure apparatus of claim 33, wherein the first blocking means comprising a sleeve crimped around a section of the connector line.
